(19) United States
(12) Patent Application Publication
(10) Pub. No.: US 2014/0351722 A1
(43) Pub. Date: Nov. 27, 2014

(54) USER INTERFACE ELEMENTS FOR MULTIPLE DISPLAYS

(71) Applicant: Microsoft, Redmond, WA (US)

(72) Inventors: Steve Frederickson, Seattle, WA (US); Henri-Charles Machalani, Seattle, WA (US); Zoran Dimov, Seattle, WA (US); Graham Wardle, Seattle, WA (US); Christopher Swan, Bellevue, WA (US); Marina Dukhon Taylor, Kirkland, WA (US); Keith Kelly, Sammamish, WA (US)

(73) Assignee: Microsoft, Redmond, WA (US)

(21) Appl. No.: 13/901,522

(22) Filed: May 23, 2013

(51) Int. Cl. G06F 3/0481

(52) U.S. Cl. CPC G06F 3/0481
USPC 715/761

(57) ABSTRACT

Described herein are techniques for a computing device executing a windowing system that automatically maintains a tiled arrangement of application windows on a first display and on a second display. A user interface element has indicia of applications that can be used to open the applications. Responsive to a first user input the user interface element is displayed on the first display, and while the user interface element is displayed on the first display, the windowing system maintains two or more of the application windows in a tiled arrangement on the second display. The user interface element may be part of a system user interface and may be implemented in a variety of ways. For example, it may be a full-screen set of application representations, possibly user selected, or a list of recently used applications, or a list of open applications, etc.

### BACKGROUND

In the field of computing, windowing environments have been used to provide applications with windows. Applications or programs executing on a computing device may have corresponding application windows through which a user interacts with the applications. In addition, it has been known how to concurrently display windows on multiple displays locally connected to one computing device. Typically, an operating system of a multi-display computing device handles details for managing multiple displays and may provide different display modes such as display mirroring or display concatenation.

Usually, windowing systems or environments include systemic user interface elements that a user can interact with to control and manage windows. For example, OS X™ has an “app launcher” tool, the Android™ operating system provides a default “Launcher” that is used to start applications and access system settings, and various versions of Microsoft Windows™ have provided a “Start” element, fast-switch lists, and other elements. In addition, there have been many third-party applications that have provided similar functionality.

To date, such user interface elements for controlling applications have been unable to work efficiently and intuitively in the presence of multiple displays connected to a same device. Add-on user interface programs for application management often lack logic, perhaps at the kernel level, that might be helpful for smooth and consistent use across multiple displays. System-provided application managers such as those mentioned above have not been designed for a multi-display user experience and therefore fall short of providing the behavior a user might expect when using multiple displays.

Techniques related to providing application management user interface elements for computing devices with multiple displays are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Described herein are techniques for a computing device executing a windowing system that automatically maintains a tiled arrangement of application windows on a first display and on a second display. A user interface element has indicia of applications that can be used to open the applications. Responsive to a first user input the user interface element is displayed on the first display, and while the user interface element is displayed on the first display, the windowing system maintains two or more of the application windows in a tiled arrangement on the second display. The user interface element may be part of a system user interface and may be implemented in a variety of ways. For example, it may be a full-screen set of application representations, possibly user-selected, or a list of recently used applications, or a list of open applications, etc.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a computing device having a first display and a second display.

FIG. 2 shows example window layouts provided by a tiled windowing system.

FIG. 3 shows window operations that may be performed either manually or as a result of system events.

FIG. 4 shows a graphical user interface provided by or implemented on top of the tiled windowing system.

FIG. 5 shows an example of a full-screen application launcher.

FIG. 6 shows an example of a user interface element that is activatable on the first display and the second display.

FIG. 7 shows a multi-display embodiment where a graphic representation may be moved across displays by the user.

FIG. 8 shows an embodiment implementing the application launcher on multiple displays.

FIG. 9 shows the application launcher displayed on the second display.

FIG. 10 shows details of a computing device.

### DETAILED DESCRIPTION

Embodiments described below relate to providing application management user interface elements for computing devices with multiple displays. Discussion will begin with an overview of windowing systems for multiple displays. Tiled or non-occluding windowing systems will be discussed next. User interface elements for application window management and manipulation will be discussed next, followed by explanation of how such user interface elements can be integrated into a multi-display setting.

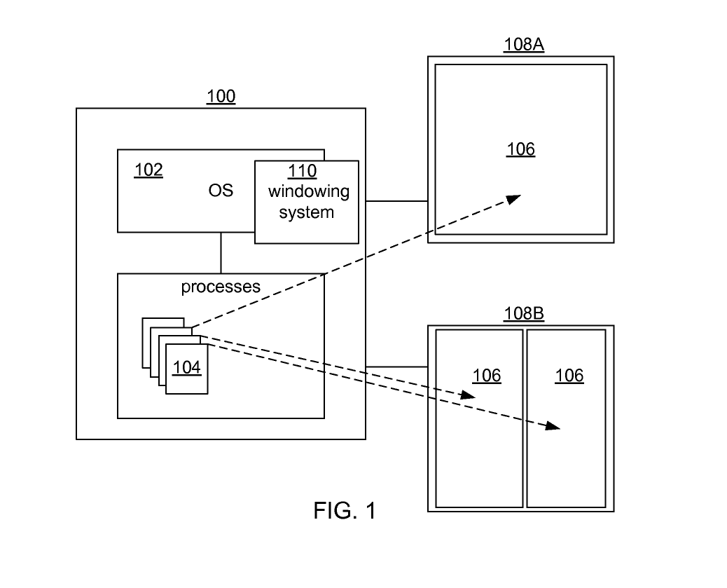

FIG. 1 shows a computing device 100 having an operating system 102 managing application processes 104 and displaying corresponding windows 106 on a first display 108A and a second display 1088, which may be connected to a display adapter or graphics ports of the computing device 100 (as used herein, “first display” and “second display” refer to any arbitrary displays and do not imply an order). For discussion, reference numeral “108” will indicate a display that may be either of the displays. In addition, all discussion herein of two displays is readily extendable to three or more displays; any description involving two displays implicitly applies to possible additional displays.

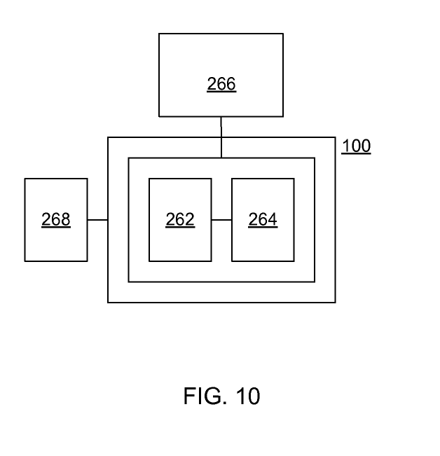

The computing device 100 may be any of a variety of types which are described later with reference to FIG. 10. The computing device 100 may be assumed to have at least storage and a processor for, respectively, storing and executing the operating system 102 and the application processes 104. Although there may be windowing systems with individual windows that represent multiple processes, and also processes without windows, for ease of discussion application processes 104 are assumed herein to each have at least a corresponding window 106 (also to be referred to as application windows). Processes 104 are well known operating system objects that are discretely managed units of execution, typically having a process identifier, memory at least partially managed by the operating system (heap and/or stack memory), and may be managed using a process table of process identifiers that is maintained by the operating system 102.

A windowing system 110 may be partly integrated with or closely coupled with the operating system 102. For purposes herein, distinctions between these components are not significant; an operating system itself may be considered to be a windowing system. The windowing system 110 may have functionality that is known in the computing arts, such as handling of input events (e.g., touches/strokes, clicks, keypresses, mouse drags, etc.) inputted by a user with various types of input devices. The windowing system 110 also manages the application windows 106 by handling related events or user interactions such as closing windows, moving windows, resizing windows, directing input to windows, rendering multiple concurrent windows, and others. The windowing system 110 may also provide a background and system controls (user interface elements) not specific to an application, which will be addressed further below.

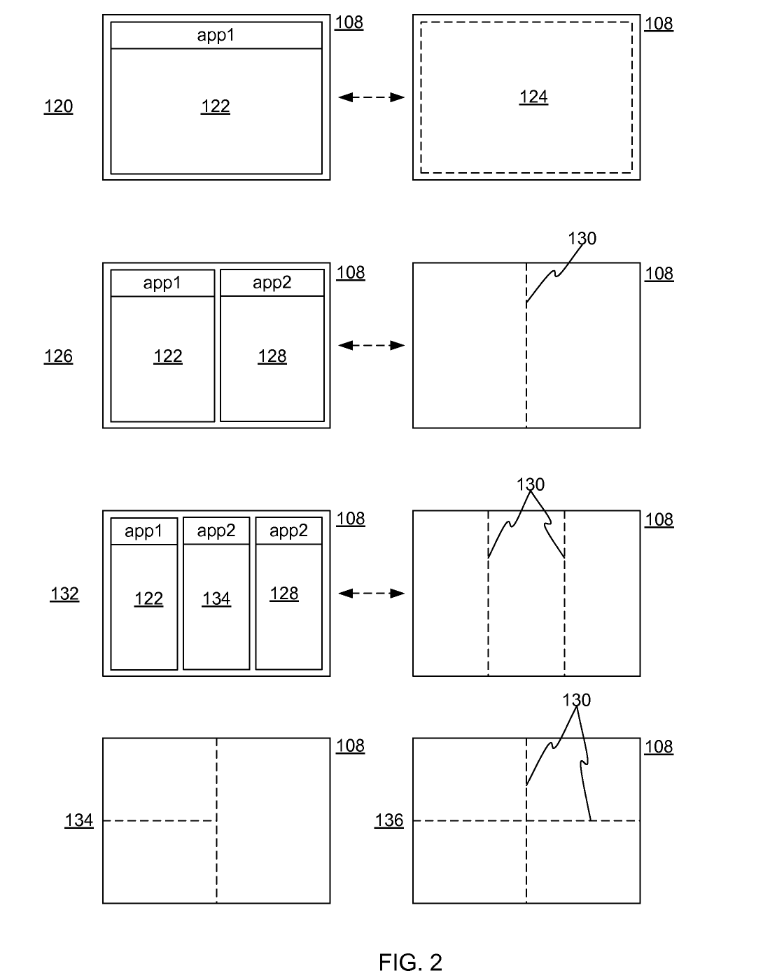

FIG. 2 shows example window layouts provided by a tiled windowing system. A tiled windowing system may manage shared display space (including multiple displays) for application windows such that the application windows substantially maximize occupancy of display space, in some cases without allowing application windows to occlude each other. In some cases, occlusion might be temporarily employed, for example to preview manual window rearrangements, to show windows being dragged or other transient conditions, to preview an expected operation, to display a dialog, to display systemic user interface elements, etc. In addition, substantially maximizing occupancy of a display refers to sizing application windows to cover display space up to or near the edges of a display, perhaps with some space allowed for system user interface elements such as resizing dividers, a clock, aesthetic margins, small gaps, information banners, and so forth.

Some tiled windowing systems may omit from windows traditional window elements such as borders, title bars, menu bars, and other elements. That is to say, application windows may have immersive qualities, for instance they may have minimal or no window adornments and may have an appearance typically associated with the “full screen” mode of many software applications. Application windows may have such appearance even in cases where multiple application windows are displayed on a same display.

Returning to FIG. 2, the first example layout 120 shows a first application window 122 substantially occupying the display 108 or a managed display region 124 managed by a tiled windowing system.

The second example layout 126 reflects the addition of a second application window 128, whether automatically or interactively inserted; the tiled windowing system automatically manages the window layout to cause the currently displayed application windows 122, 128 to somewhat maximize occupancy of the display 108. The tiled windowing system (window manager) may insert between windows a divider 130 that can be moved by a user to resize the application windows adjacent to the divider 130 while maintaining a tiled arrangement.

The third example layout 132 shows a third application 134 having been inserted. With tiled layout management, a user may only needs to designate the third application window 134 to be inserted and/or possibly designate a slot or location for inserting the third application window 134; the tiled window manager may automatically resize the displayed application windows or take other measures to accommodate the new application window.

The fourth and fifth example layouts 136, 138 show other divisions of screen real estate that may be used. For ease of discussion, examples discussed below show tiling using only a single horizontal row of application windows, however, any arbitrary rectilinear arrangement may be used, possibly with asymmetries.

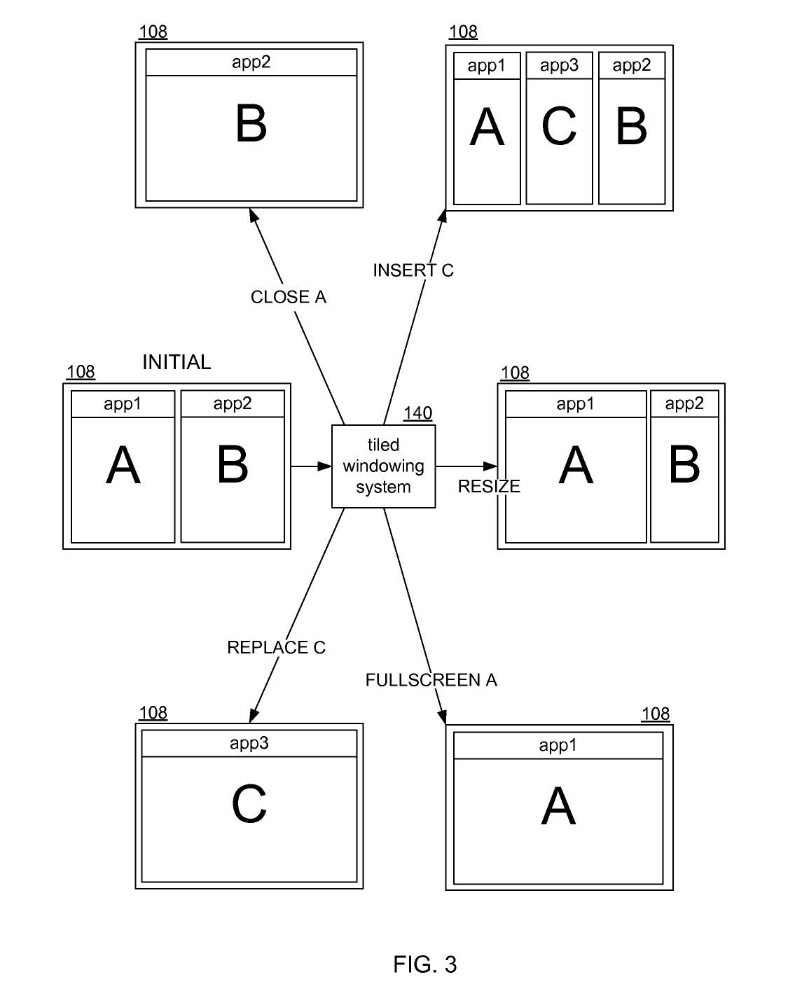

FIG. 3 shows window operations that may be performed either manually or as a result of system events. Given an initial window arrangement on the display 108, a tiled windowing system 140 may close application A resulting in application B being automatically resized to occupy the display 108. An application might be closed manually or might be closed due a system event such as an error. When application C is inserted into the initial layout applications A and B are automatically resized by the tiled windowing system 140 to accommodate the newly displayed application window of application C. A resize operation may be performed, for example by user manipulation of a divider 130, to change the apportionment of display space for the application windows. If a currently displayed application or another application enters a fullscreen mode or is resized to substantially fully (exclusively) occupy the display 108, then the other application windows are evicted from the display 108. The user may select an application (e.g., application C) to replace any other applications displayed.

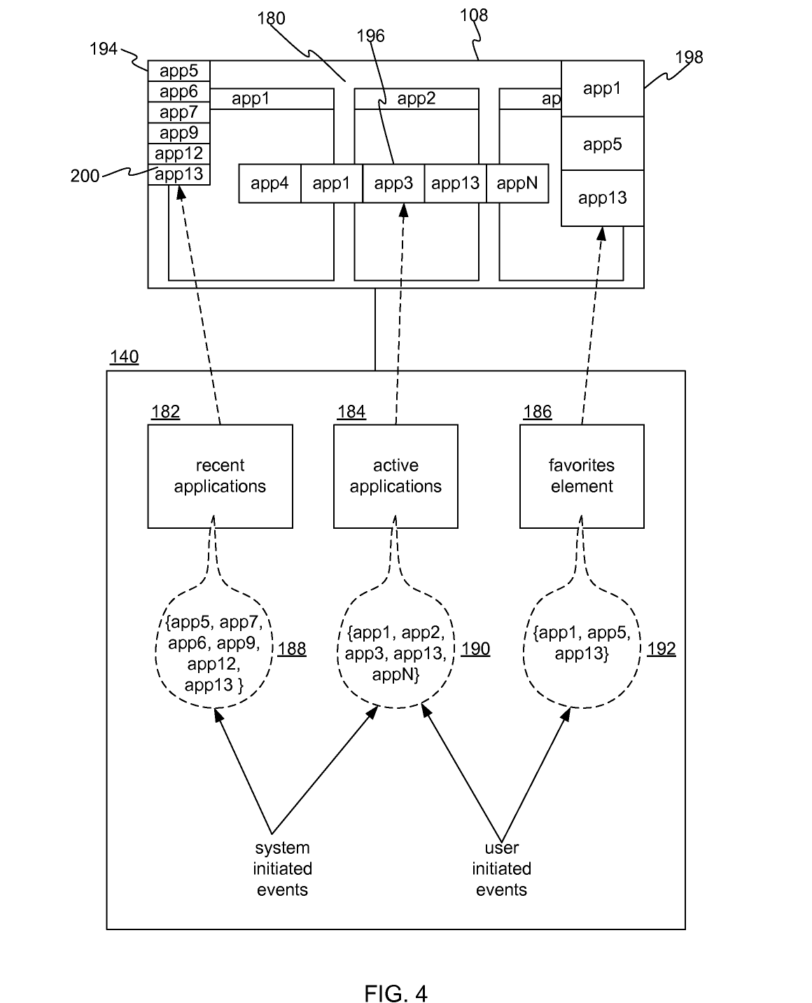

FIG. 4 shows a graphical user interface 180 provided by or implemented on top of the tiled windowing system 140. The elements and features of the graphical user interface 180 are only examples and other types of features are contemplated and equally applicable to application windows and application groups (for example, a search feature might return both applications and application group objects). In addition, at times some or all of the user interface elements of the graphical user interface 180 may not be displayed or are only displayed when requested per input from a user.

The tiled windowing system 140 may have various features or facilities that allow a user to manage applications on the computing device. Such features, which are sometimes referred to herein as “user interface elements”, or “system elements”, might include a recent applications module 182, an active applications module 184, and/or a favorites module 186.

These modules cooperate with the windowing system (or are a part thereof) to track the semantically relevant information. When applications are opened or used the windowing system might populate a recent-applications list 188 with indicia of recently used applications. The windowing system might similarly populate or provide an active-applications list 190, which might include applications currently displayed on any connected monitors and/or applications that are executing or suspended but are not currently displayed. Similarly, a user might maintain a favorite-applications list 192.

These lists are used by the graphical user interface 180 to display corresponding user interface elements 194, 196, 198 that can be invoked and used by the user to activate applications or application groups, as the case may be. In some embodiments, the user interface elements 194, 196, 198 may be persistently displayed, and in other embodiments they are displayed only when activated by a user input such as after pressing and releasing a hardware or software button, or while a hot key is depressed, or after inputting a touch gesture, etc. Some of the user interface elements 194, 196, 198 may be undisplayed when they are used to open an application, or when display-sustaining input ends, or when a user invokes a close command.

The system user interface elements 194, 196, 198 in FIG. 4 are only examples and other bases for providing lists of applications may be used. For example, an “all applications” user interface element may be provided to show user-activatable graphic representations of all applications formally installed on the computing device. Any of the above-discussed types of user interface elements may also be implemented as full-screen elements and may, for example, be managed by the windowing system as special types of application windows.

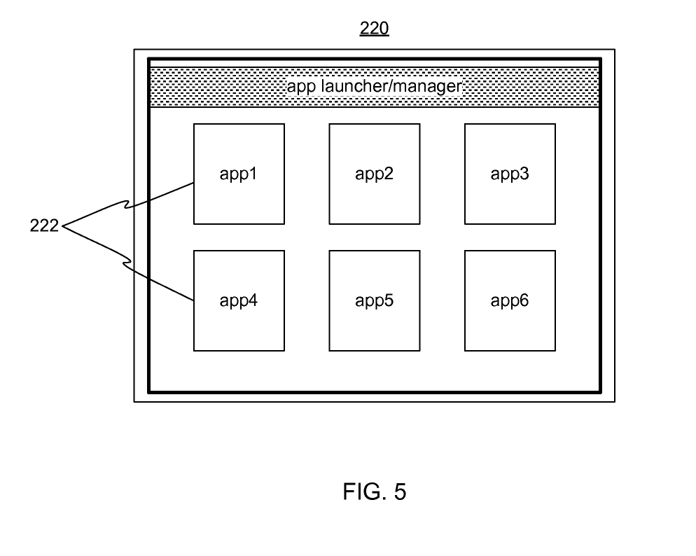

FIG. 5 shows an example of a full-screen application launcher 220 (another type of system user interface element, sometimes referred to as a “launcher”, “switcher”, graphical user shell, etc.). The full-screen application launcher 220 is another means for allowing a user to interactively manage applications. The application launcher 220 may be user-configurable, for instance having user-selected or user-arranged application representations 222 representing corresponding applications. As used herein, the term “launch” refers to both initially opening an application (e.g., starting a new process) as well as well as opening (displaying) the already-running (possibly dormant) application window for an application.

In one embodiment, an application representation 222 may display dynamically updated content received, for example, from other applications, system services, or from network-based resources. Such live updating may occur even when an application representation's application is not open. The app launcher may be implemented as a scrollable surface, and may also include dashboard-like features such as a clock, a logout mechanism, network status information, system or application notifications, and so forth. At times, as discussed below, the application launcher 220 is not displayed until requested by a user.

Application representations 222 may be interactively rearranged, removed, added, perhaps resized, configured with settings, updated by applications with dynamic content, etc. Application representations 222 may also be activated or selected by a user to open a corresponding application window. In some embodiments, the application launcher is undisplayed when a graphic application representation 222 is actuated to open an application window; the opened application window may supplant the application launcher on the display where the application launcher was used.

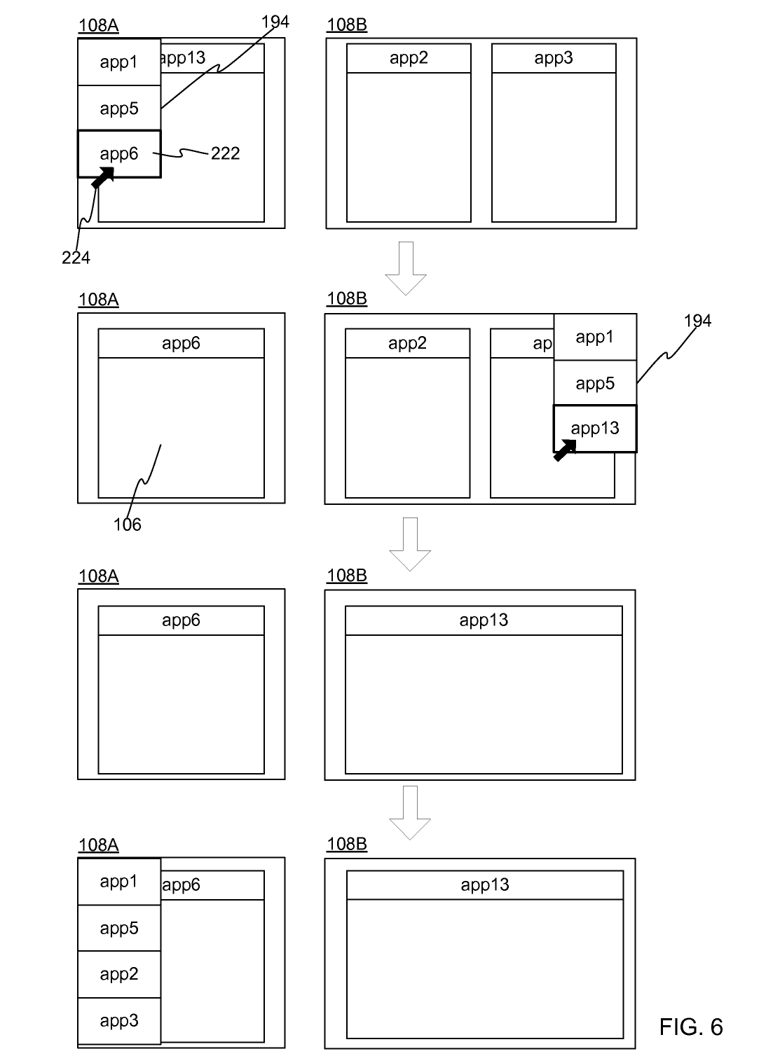

FIG. 6 shows an example of the user interface element 194 that is activatable on the first display 108A and on the second display 1088. For brevity, only multi-display behavior of the user interface element 194 (corresponding to the recent-applications list 188) will be described. However, this multi-display behavior can be readily implemented in any other type of system user interface element.

The user interface element 194 includes graphic application representations 222 of corresponding applications. An application representation may be displayed as a thumbnail image of the corresponding application (live or previously captured) or a graphic symbol representing the application. The application representation 222 may be interactively selected, for instance by a click or touch, or dragged from the user interface element 194 by the user. When the application representation 222 is activated or released from a drag the corresponding application window is opened. Various visual effects may be used. For instance, a rendering of the prior or emerging layout may be animated as enlarging to occupy the display before switching to live activation of the windows. In some embodiments, the application representation 222 may represent a group of applications and can be used to open those applications all at once. Note that a pointer 224 may or may not be displayed, and in this description the pointer 224 may also depict not a graphic pointer but rather an input point moved or inputted by a user.

Regarding the multi-display behavior of the user interface element 194, the user interface element may, in one embodiment, be opened by the user on either the first display 108A or on the second display 1088, and optionally may not be able to be displayed simultaneously on both displays, as shown in the four sequential stages of FIG. 6. In addition, when the user interface element 194 is displayed, the application windows on the other display (the display not displaying the user interface element 194) are maintained; they are not affected. Thus, one display may have a system user interface element while the other display has one or more application windows and interaction with one need not affect the other.

Sequentially, the user interface element 194 is initially not displayed but is available to be activated by the user on either the first display 108A or the second display 1088. As shown in the first quarter of FIG. 6, the user interface element 194 is displayed per user input and shows application representations 222 corresponding to recently used applications. Note that at this time the same application representations will be displayed regardless of which display the user interface element 194 is displayed on. However, when the application representation 222 for application “app6” is activated by the user, the user interface element 194 is undisplayed and the tiled windowing system opens and displays the application window 106 for application “app6” on the same display where the user interface element 194 was displayed; on the first display 108A. Because application “app6” is now active, it is removed from the recent-applications list 188 (or potentially the source monitor, in the case where it was visible on the other display) and application “app13”, which was replaced on the first display 108A by application “app6”, is added to the recent-applications list 188 (at this time, if the user interface element 194 were opened on the other display it would include “app13” but not “app6”). Note that the opening of the application window 106 for application “app6” does not affect the application windows displayed on the first display 108B, which continue to be displayed and available for interactive multitasking.

When the user activates the user interface element 194 on the second display 1088, as shown in the second quarter of FIG. 6, the user selects the application representation for application “app13”, which in turn alters the content of the second display 1088 without affecting the content of the first display 108A, and which also updates the recent-applications list 188 and displays the application window of application “app13” on the second display 1088. This process may be repeated indefinitely for arbitrary applications. The multi-display behavior may be implemented without requiring any one of the displays to be designated as a master or controlling display; the displays are treated as equal peers with respect to the user interface element 194 (or potentially any other user interface element) and the effects of its use.

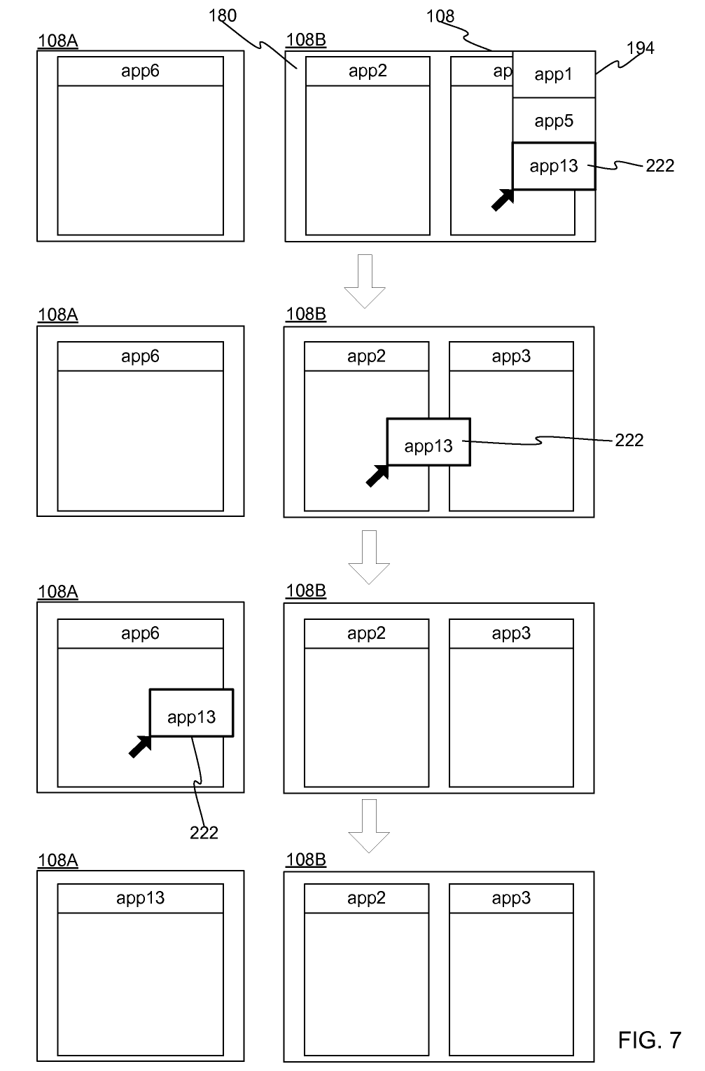

FIG. 7 shows a multi-display embodiment where a graphic representation 222 may be moved across displays by the user. In this case, the graphic representation is dragged out of the user interface element 194 and can be deposited on either the initial display (e.g., second display 1088) or the other display. The target application (“app13”) may either replace another application or may be inserted among other applications. If the application representation 222 is dropped on the other display (after being moved across displays) then the unified recent-applications list 188 is updated accordingly to include the application replaced on the other display; e.g., application “app6” is added.

As can be seen from the discussion above, the content of the recent-applications list 188 and the appearance of the user interface element 194 is consistent across multiple displays, regardless of which display it is displayed on or which display an application windows is opened to. In addition, activity limited to one display does not affect what is displayed any other display, although if dormant the user interface element 194 will reflect such activity if later displayed on the other display.

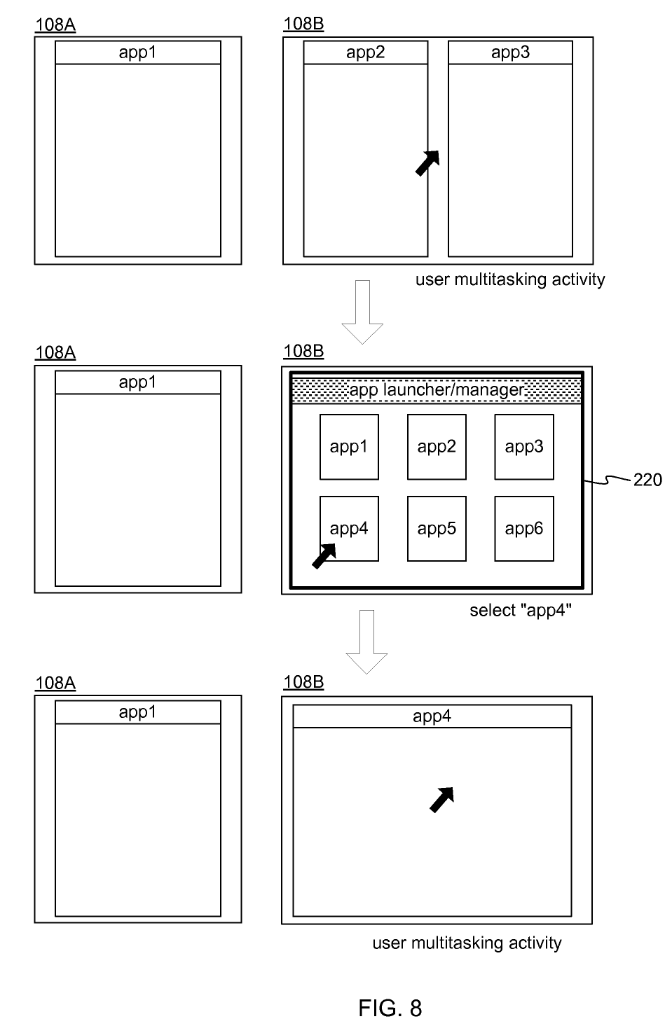

FIG. 8 shows an embodiment implementing the application launcher 220 on multiple displays. Initially, as shown at the top of FIG. 8, both the first display 108A and the second display 1088 display one or more tiled (or immersive) application windows which are all available for multitasking user interactivity. There may be predefined inputs, e.g., gestures, key combinations, hardware or software buttons, etc., that can be inputted by the user to activate (display) the application launcher 220. While these activation inputs are not specific to any particular display, which display they will affect may depend on which display is currently being used by the user (e.g., which display has a pointer or which display has a window receiving user input, etc.). Or, which display an invocation input for the application launcher 220 will be directed to may be determined directly if the display also serves as or is joined with an input layer.

When a user input is received and directed to a particular target display, which at one time could be either display, the windowing system displays the application launcher 220 on that target display, as shown in the middle portion of FIG. 8. At the same time, the one or more application windows on the other display(s) (the non-target display(s)) are not directly affected by the display of the application launcher 220; they continue to be available for multitasking user input. Similarly, when the application launcher 220 is dismissed or undisplayed (explicitly or implicitly), the one or more application windows on the other display are not affected.

When the application launcher 220 is displayed on one arbitrary display, user input directed to the other display, for instance interacting with an application window, does not cause the application launcher 220 to be undisplayed; the application launcher 220 remains available to be used by the user, possibly displaying live information in dashboard fashion or providing other system functionality. If the application launcher 220 is displayed on a first display and launcher-invoking input is directed to a second display, then the application launcher 220 is removed from the first display and is displayed on the second display.

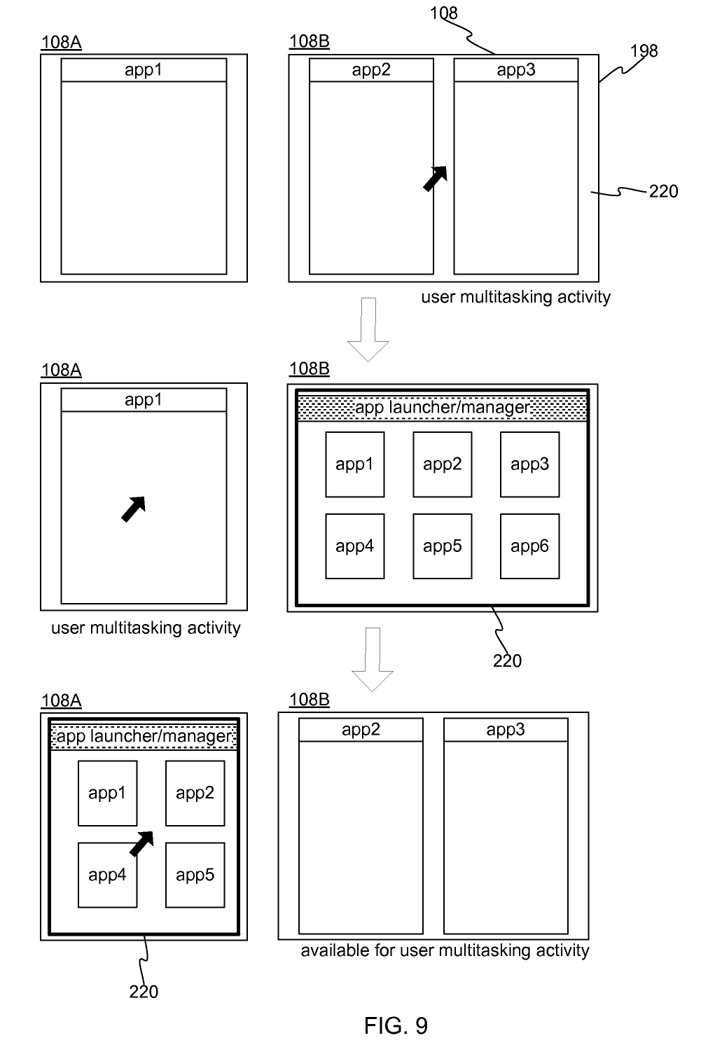

FIG. 9 shows the application launcher 220 displayed on the second display 1088. When the user is multitasking on the first display 108A and activates the application launcher 220, the windowing system shifts the application launcher 220 from the second display 1088 to the first display 108A; any subsequent multitasking on the second display 1088 need not affect the application launcher 220 on the first display 108A (the converse is also true).

As shown in the middle portion of FIG. 8, the displayed application launcher 220 can be interacted with to open an application window or perform other application-management functions. When the application representation for application “app4” is selected by the user, the corresponding application window is displayed on the same display that was displaying the application launcher 220 (this might also update an application list used by one of the user interface elements 194, 196, 198). In one embodiment, the selected application window replaces the application launcher 220 and is displayed to substantially fully occupy the display, while at the same time any application windows on the other display are not affected. In one embodiment, the user can provide input to explicitly hide the application launcher 220, which may result in re-display of the application window(s) that were displayed before the application launcher 220 was opened.

At times one or more of multiple displays may be disconnected or become inoperable. An application capture feature may be implemented to respond to the loss of a display by capturing indicia of the application windows that were displayed on that display. If the display or displays is/are reconnected within a predetermined period of time (e.g., five minutes), then the application windows are automatically displayed on the display or displays to reproduce the appearance of the display or displays before it/they was/were disconnected. Note that if all displays are disconnected, this timer might not apply. That is to say, there may be scenarios where there are no available displays, such as when display drivers are updating, when connecting to a remote machine, or occurrence of some system failures. In such cases, all screens can be restored.

Further regarding how an operating system and/or a windowing system handle multiple monitors, the windowing system may also allow applications to be interactively moved across displays. For example, a user might be allowed to drag a window on a first display over to a second display (or, the user might input a “switch displays” command). That is to say, the windowing system is able to maintain a tiled arrangement and provide user interface elements seamlessly within a concatenated display model.

As can be seen from the embodiments described above, when a computing device has only one connected display, a number of system user interface elements may be available to open applications or perform other application management functions. When a second display is connected, those system user interface elements, even if dormant or not currently displayed, become equally available to be activated on both displays. In addition, their display or use on one display need not affect the contents of the other display. When the user interface elements are deactivated or undisplayed from one display, the contents (e.g., windows) of the other display may continue to be displayed thereon.

FIG. 10 shows an example of the computing device 100 on which embodiments described above may be implemented. The computing device 100 may have one or more displays 266, as well as storage devices 262 and a processor 264. These elements may cooperate in ways well understood in the art of computing. In addition, the input devices 168 may be integrated with or in communication with the computing device 100. The displays 266 may be any variety of devices used to display a signal outputted by computing devices, including, for example, solid-surface displays (e.g., plasma, liquid crystal), projectors, touch-sensitive surfaces, and others. The computing device 100 may have any form factor or be used in any type of encompassing device. For example, touch-sensitive control panels are often used to control appliances, robots, and other machines. The computing device 100 may be in the form of a handheld device such as a smartphone, a tablet computer, a gaming device, a headless server, or others.

Embodiments and features discussed above can be realized in the form of information stored in volatile or non-volatile computer-readable or device-readable devices. This is deemed to include at least devices such as optical storage (e.g., compact-disk read-only memory (CD-ROM)), magnetic media, flash read-only memory (ROM), or any other devices for storing digital information in physical matter. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method of managing windows for a computing device, the method comprising:
executing a windowing system that automatically maintains a tiled arrangement of application windows for applications executing on the computing device, the windowing system enabling tiled display of the application windows on a first display connected with the computing device and on a second display connected with the computing device, wherein when one or more application windows are displayed by the windowing system on either of the displays those application windows substantially fully occupy the displays on which they are displayed;
executing an application launcher on the computing device, the application launcher comprising indicia of applications on the computing device, wherein responsive to a first user input the application launcher is displayed on the first display; and
while the application launcher is displayed on the first display, maintaining, by the windowing system, two or more of the application windows in a tiled arrangement on the second display.

2. A method according to claim 1, further comprising, responsive to second user input, displaying the application launcher, an application switcher, or dashboard of information on the second display and concurrently maintaining tiled arrangement of one or more of the application windows in a tiled arrangement on the first display.

3. A method according to claim 1, wherein the application launcher at one time is able to be displayed on the first display and is able to be displayed on the second display, according to invoking user input.

4. A method according to claim 3, wherein the application launcher when displayed substantially fully occupies whichever of the displays that it is displayed on.

5. A method according to claim 1, wherein the application launcher comprises a plurality of graphics representing respective applications and when a graphic is selected a corresponding application is launched and a corresponding application window substantially fully occupies whichever display was displaying the application launcher when the graphic was selected.

6. A method according to claim 5, wherein when the application window is closed or moved to another display, the application launcher is again displayed on the same display.

7. A method according to claim 1, wherein the application launcher comprises a list of recently used applications, the application launcher is able to be displayed on both the first display and the second display, and is only able to be displayed on one display at a time.

8. A method according to claim 1, wherein neither display is managed as a main display but rather each display is equally capable of displaying the application launcher while the other display displays one or more application windows.

9. A computing device comprising a processor, storage, and a first display, the storage storing a windowing system that when executed by the processor displays application windows of applications executing by the processor, the computing device further comprising:
the windowing system, when executing, being capable of displaying application windows on the first display and on a second display when a second display is locally connected with the computing device, the windowing system further comprising a user interface element, wherein the windowing system displays application windows on either display such that when an application window is displayed on either display the application window either substantially fully occupies that display or the application window and any other application windows on that display substantially fully occupy that display; and
the user interface element, which at one time is capable of being displayed on the first display and is capable of being displayed on the second display, being configured to respond to user interactions with the user interface element by displaying application windows on whichever display is currently displaying the user interface element.

10. A computing device according to claim 9, wherein the windowing system allows the user to direct input to both of the displays and allows the user to move application windows from one display to the other.

11. A computing device according to claim 9, wherein when the user interface element is being displayed on one display: the user is able to interact with any application windows displayed on the other display, the user is able to interact with the user interface element without disrupting display of any application windows displayed on the other display, and the user is able to interact with the user interface element to trigger the display of application windows.

12. A computing device according to claim 9, wherein when an application window is displayed responsive to a user interaction with the user interface element, the user interface element is undisplayed and the application window is displayed on the display where the user interface element was interacted with, the application window being displayed such that the application window substantially fully occupies the display where the user interface element was interacted with.

13. A computing device according to claim 9, wherein the user interface element comprises application icons for launching corresponding applications.

14. A computing device according to claim 13, wherein the user interface element comprises a full-screen window that also displays content updates received by the computing device via a network.

15. A computing device according to claim 9, wherein the application windows are not able to overlap per the windowing system, and wherein the computing device further comprises a window-containing window that contains application windows that are allowed to overlap, the window-containing window invocable by interaction with the user interface element and the window-containing window not being allowed to overlap with application windows not contained therein.

16. One or more computer storage devices storing information to enable a computing device to perform a process, the process comprising:
executing applications having respective application windows displayable by a windowing system executing on the computing device;
displaying a first application window on a first display connected with the computing device and displaying a second application window on a second display connected with the computing device, each application window substantially fully occupying the display on which it is displayed;
enabling a user to direct input to the first display to interact with the first application window while concurrently enabling the user to direct input to the second display to interact with the second application window;
providing an application-list comprising a set of application representations that when displayed can be interacted with by the user to open application windows of respectively represented applications, the application-list able to be displayed, at any given time, responsive to user input, by either (i) only one display at a time or (ii) by both displays at a time;
responsive to user input directed to an arbitrary one of the displays, displaying the application-list over either the first application window or the second application window, according to which one of the displays the user input is directed to; and
responsive to further user input selecting one of the application representations: undisplaying the application-list and displaying a third application window corresponding to the selected application representation on the one of the displays while maintaining the displaying of the first or second application window on the display other than the one of the displays.

17. A storage device according to claim 16, wherein which application representations are included in the application-list is dynamically determined according to interactive openings or closings of application windows on the first display and on the second display.

18. A storage device according to claim 17, wherein the application representations represent applications recently used by the user but not currently displayed.

19. A storage device according to claim 16, wherein the further user input comprises a drag input that drags the selected application representation from the application-list and the process further comprises enabling the user to interactively drag the application representation to determine either which display will display the third application window or where on either display the third application window will be displayed.

20. A storage device according to claim 19, the process further comprising enabling, by the windowing system, interactive dragging of application windows between the first display and the second display.
